(19) United States
(12) Patent Application Publication
(10) Pub. No.: US 2008/0025855 A1
(43) Pub. Date: Jan. 31, 2008

(54) Piston Pump And Piston Ring

(75) Inventors: Norbert Alaze, Markgroeningen (DE); Horst Beling, Heilbronn (DE)

Correspondence Address: RONALD E. GREIGG;GREIGG & GREIGG P.L.L.C., 1423 POWHATAN STREET, UNIT ONE, ALEXANDRIA, VA, 22314, US

(73) Assignee: ROBERT BOSCH GMBH, Stuttgart (DE)

(21) Appl. No.: 11/718,734

(22) PCT Filed: Oct. 12, 2005
(86) PCT No.: PCT/EP05/55185

§ 371 Date: May 7, 2007

(30) Foreign Application Priority Data
Nov. 24, 2004 (DE) 10 2004 056 660.7

(51) Int. Cl. F04B 39/10; F16J 9/14

(52) U.S. Cl. 417/509; 277/497

(57) ABSTRACT

A piston pump includes a pump housing in which a pump piston is guided axially movably, so that upon an actuation of the pump piston a fluid is pumped from a suction side of the piston pump to a compression side of the piston pump via a pump chamber adjoining the pump piston. According to the invention, the pump piston is guided by means of a piston ring which has a dividing point that is sealed in a radially and axially pressure-reinforced manner.

### PRIOR ART

The invention is based on a piston pump of the type defined in detail by the preamble to claim 1 and on a piston ring of the type defined in detail by the preamble to claim 7.

A piston pump of this kind is known in the industry and is for instance a component of a hydraulic vehicle brake system. The known piston pump has a pump housing in which a pump piston is axially displaceably guided. A bush that is inserted into a bore in the pump housing may be provided for guiding the pump piston. For guidance and sealing, the pump piston has a tubular insert, which is provided with an annular collar and onto which a restoring spring also acts that prestresses the pump piston in the direction of an eccentric element by means of which the pump piston is driven. The insert serving as a combined guiding and sealing element is exposed to wear in the region of its circumferential face, so that the service life of the piston pump is limited.

In the industry, piston rings for sealing a guide region of pistons are also know that are made from PTFE (polytetrafluoroethylene). As a rule, these are embodied as open rings, and in their parting region they are equipped with either a straight joint, an oblique joint, a simply overlapping joint, or a so-called gas-tight joint. However, piston rings of PTFE are expensive to manufacture, since they can be machined only in metal-cutting fashion. With these piston rings as well, it is not always assured that at the pressures prevailing in piston pumps of hydraulic brake systems, they will guarantee adequately high tightness.

### ADVANTAGES OF THE INVENTION

The piston pump of the invention having the characteristics of the preamble to claim 1 and having a pump piston which is guided by means of a piston ring that has a dividing point that is sealed in a radially and axially pressure-reinforced manner has the advantage that by means of a simple component, tightness over the service of the piston pump in the guide region of the pump piston can be achieved that meets the demands made in the field of motor vehicle brake systems or the like. Since in the case of a dividing point sealed with radial and axial pressure reinforcement, overlapping regions exist in both the radial and the axial directions, even if wear occurs to the piston ring on its circumferential face, long-term functioning of the piston pump with unchanged efficiency is assured.

The piston pump of the invention can be used in particular as a pump in a motor vehicle brake system and in this case can serve to control the pressure in wheel brake cylinders. The piston pump of the invention is used for instance in a brake system with wheel slip control (ABS or ESP) and/or in an electrohydraulic brake system (EHB). The pump then serves for instance to return brake fluid from one or more wheel brake cylinders to a master cylinder (ABS) and/or to pump brake fluid out of a supply container into one or more wheel brake cylinders (TCS or VDC or EHB). The pump can also serve to fill a reservoir in the brake system. With wheel slip control, locking of the wheels in a braking event (ABS) and/or spinning of the driven wheels of the vehicle (TCS) can be averted. In a brake system serving as a steering aid (VDC), a brake pressure is built up in one or more wheel brake cylinders independently of an actuation of the brake pedal or gas pedal, for instance to prevent the vehicle from breaking out of the lane chosen by the driver. If the pump is used in conjunction with an electrohydraulic brake system (EHB), the pump pumps the brake fluid into the wheel brake cylinder or cylinders if an electric brake pedal sensor detects an actuation of the brake pedal.

In a special embodiment of the piston pump of the invention, the piston ring, in the region of the dividing point, has annular end regions meshing with one another, which each have a respective tab which rests radially on the inside on a support region of the other annular end region and is axially defined by the tab of the other annular end region. Particularly with this design, each annular end region has a recess for the tab of the other annular end region, and between the two tabs and the two end regions gaps are closed by the fluid pressure prevailing particularly in the pump chamber, since this pressure, via an annular gap located between the piston ring and the pump piston, acts on both the inside of the piston ring and a face end of the piston ring. Accordingly, sealing is accomplished both axially and radially outward in the direction of a wall, associated with the housing and serving to guide the pump piston, and in the direction of a gap between the pump piston and this wall.

A preferred embodiment of the piston pump of the invention exists if the piston ring is an injection-molded part. In that case, the piston ring is accordingly made from an injection-moldable material, in particular a polymer, and the polymer is formed for instance of a filled or unfilled polyamide or of PEEK (polyetheretherketone). The piston ring is then a seal and guide that can be produced economically and is wear-resistant and also withstands high pressures of the kind that occur for instance in the pressure supply to an ABS/ESP system.

In order to assure especially reliably that the pressure required for sealing is always built up on the inside of the piston ring as well so that the required sealing action is attained, the piston ring in a preferred embodiment has spacers on its inside. These spacers define the width of an annular gap between the pump piston and the inside of the piston ring.

In a special embodiment of the piston pump of the invention, the spacers are formed by axial ribs which are braced on the pump piston. The ribs thus absorb a force of the pump piston acting in the radial direction that is required for guiding the pump piston. For radial compensation of tolerances in a receiving region for the piston ring, the ribs can be intentionally plastically supercompressed to a certain amount without adversely increasing the friction between the piston ring and the wall for guiding the pump piston. Thus by a flowing of the material comprising the ribs, which occurs when the piston ring is pressed onto the pump piston, an optimal fitting of the piston ring into the piston pump can be accomplished. Naturally, instead of ribs, protrusions such as bumps or the like may also be provided as spacers.

The invention also has a piston ring for guiding and sealing a pistonlike component in a cylindrical receiving chamber as its subject. The piston ring has a dividing point, in the region of which, annular end regions meshing with one another are provided, which each have a respective tab which rests radially on the inside on a support region of the other annular end region and is axially defined by the tab of the other annular end region. A piston ring of this kind can bring about reliable axial and radial sealing, which in each case is pressure-reinforced.

Further advantages and advantageous features of the subject of the invention can be learned from the description, drawings and claims.

### DRAWINGS

One exemplary embodiment of a piston pump of the invention is schematically shown in simplified form in the drawing and described in further detail in the ensuing description.

FIG. 1 shows a longitudinal section through a piston pump, embodied according to the invention, of an electrohydraulic brake system;

FIG. 2 shows a piston ring, serving the purpose of sealing and guidance, of the piston pump of FIG. 1 in a perspective view; and

FIG. 3 shows the sealing action of the piston ring shown in FIG. 2.

### DESCRIPTION OF THE EXEMPLARY EMBODIMENT

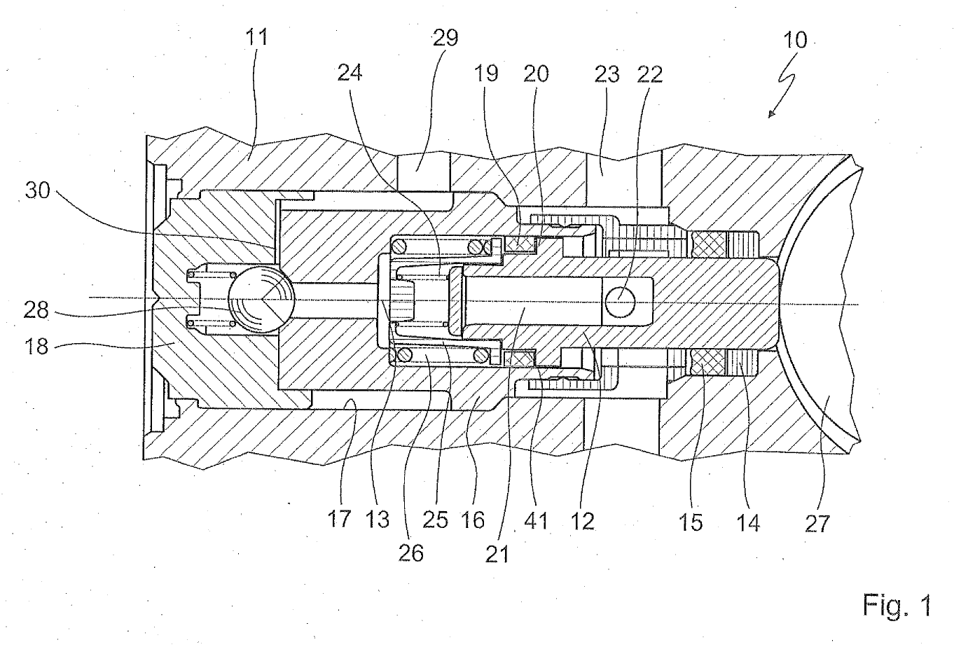

In FIG. 1, a piston pump 10 is shown, which is integrated into a hydraulic block that forms a pump housing 11. The hydraulic block is a component of a hydraulic vehicle brake system and besides the piston pump possibly includes further piston pumps of the same design as well as such hydraulic components as magnet valves or pressure reservoirs, which may be hydraulically connected to one another and to the piston pump 10 shown in the drawing.

The piston pump 10 has a pump piston 12, which is guided in the pump housing 11 and which on an end remote from a positive-displacement chamber or pup chamber 13 is guided on the pump housing 11 via a guide ring 14 and is sealed off by means of a sealing ring 15.

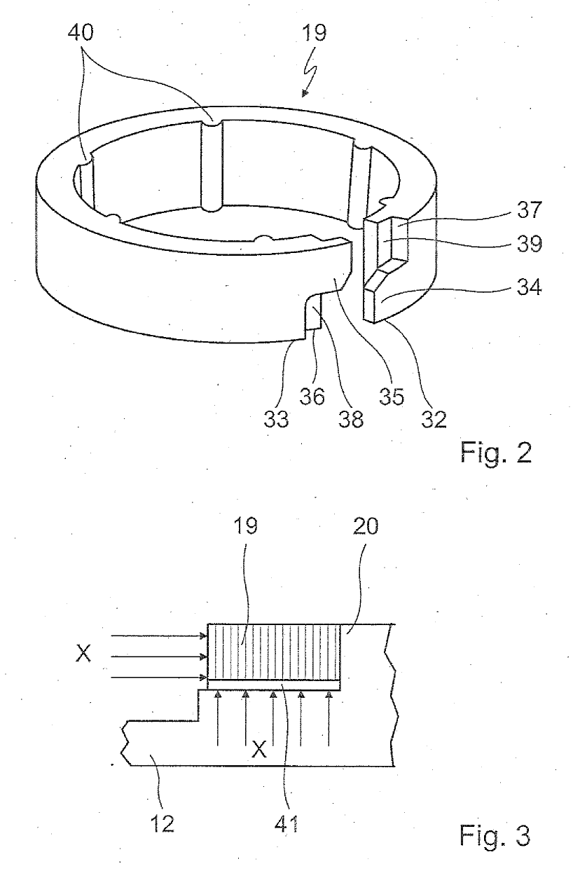

The pump piston 12 is furthermore guided on a bush 16, which is associated with the pump housing and is fitted into a bore 17 of the pump housing 11 and fixed by means of a so-called outlet valve cap 13, which also acts as a closure part for the piston pump 10 integrated into the hydraulic block. The guidance of the pump piston 12 in the bush 16 is effected via a piston ring 19, which on its face end remote from the pump chamber 13 is braced on an annular collar 20 of the piston pump 12, and whose construction and function will be described hereinafter in conjunction with FIGS. 2 and 3.

The pump piston 12 has an axial conduit 21 in the manner of a blind bore, which communicates via transverse bores 22 with an inlet conduit 23, forming a suction side of the piston pump, so that in an intake process, fuel can be pumped out of the inlet conduit 23 into the positive-displacement chamber 13. To prevent a reverse flow of fluid from the pump chamber 13 into the axial conduit 21, the pump piston 12, on its face end toward the positive-displacement chamber 13, is provided with a check valve 24, which includes an attachment 25 whose base region defines the receiving chamber for the piston ring 19, on the side diametrically opposite the annular collar 20, and upon which a restoring spring 26 acts for prestressing the pump piston 12 in the direction remote from the positive-displacement chamber 13. The restoring spring 26 presses the pump piston 12, via the attachment 25, in the axial direction against an eccentric element 27, which can be driven to rotate by an electric motor and which serves to drive the piston 12, causing it to experience a reciprocating motion.

An outlet valve 28, embodied as a check valve, is disposed in the outlet valve cap 18 and controls a fluid flow between the positive-displacement chamber 13 and an outlet conduit 29 forming a compression side of the piston pump 10; the outlet valve cap 18 is provided for that purpose, on the face end toward the bush 26, with a channel-like connecting conduit 30 that leads to the outlet conduit 29.

The piston ring 19, which is shown by itself in FIG. 2, is an injection-molded part made from filled polyamide and is embodied as an open ring, which has two end regions 32 and 33 meshing with one another, which each have a tab 34 and 35 for engaging a recess 36 and 37 in the other end region 33 and 32, respectively. The tabs 34 and 35 each engage the corresponding recess 36 and 37 in such a way that they rest on a support region 38 and 39 of the other end region 33 and 32 and are axially defined by the tab 35 and 34 of the other end region 33 and 32, respectively.

On its inside, the piston ring 19 further has axially oriented ribs 40, which are distributed uniformly over the inner circumferential surface of the piston ring 19 and act as spacers, which define the width of an annular gap 41 between the pump piston 12 and the piston ring 19, so that for attaining the sealing action, a fluid force X, represented by arrows in FIG. 3, acts on the inside of the piston ring 19. Moreover, to achieve the sealing action, the fluid force X also acts on the face end, remote from the annular collar 20, of the piston ring 19. Gaps between the end regions 32 and 33 of the piston ring 19, and in particular gaps between the tabs 34 and 35 and the respective associated support region 36 and 39 of the other end region 33 and 32, as well as a gap present between the tab 34 and the tab 35, can thus be sealed reliably.

1-10. (canceled)

11. A piston pump, comprising a pump housing, a pump piston guided axially movably in the housing so that upon an actuation of the pump piston, a fluid is pumped from a suction side of the piston pump to a compression side of the piston pump via a pump chamber adjoining the pump piston, and a piston ring having a dividing point that is sealed in a radially and axially pressure-reinforced manner, the piston ring guiding the pump piston for axial movement in the housing.

12. The piston pump as defined by claim 11, wherein the piston ring, in the region of the dividing point, comprises annular end regions meshing with one another, which end regions each have a respective tab which rests radially on the inside on a support region of the other annular end region and is axially defined by the tab of the other annular end region.

13. The piston pump as defined by claim 11, wherein the piston ring is an injection-molded part.

14. The piston pump as defined by claim 12, wherein the piston ring is an injection-molded part.

15. The piston pump as defined by claim 11, wherein the piston ring further comprises spacers on its inside.

16. The piston pump as defined by claim 12, wherein the piston ring further comprises spacers on its inside.

17. The piston pump as defined by claim 13, wherein the piston ring further comprises spacers on its inside.

18. The piston pump as defined by claim 14, wherein the piston ring further comprises spacers on its inside.

19. The piston pump as defined by claim 15, wherein the spacers are defined by axial ribs which are braced on the pump piston.

20. The piston pump as defined by claim 16, wherein the spacers are defined by axial ribs which are braced on the pump piston.

21. The piston pump as defined by claim 17, wherein the spacers are defined by axial ribs which are braced on the pump piston.

22. The piston pump as defined by claim 18, wherein the spacers are defined by axial ribs which are braced on the pump piston.

23. The piston pump as defined by claim 11, wherein the piston ring is braced in the axial direction on an annular collar of the pump piston.

24. The piston pump as defined by claim 12, wherein the piston ring is braced in the axial direction on an annular collar of the pump piston.

25. The piston pump as defined by claim 13, wherein the piston ring is braced in the axial direction on an annular collar of the pump piston.

26. The piston pump as defined by claim 15, wherein the piston ring is braced in the axial direction on an annular collar of the pump piston.

27. In a piston ring for guiding and sealing a pistonlike component in a cylindrical receiving chamber and having a dividing point, the improvement comprising annular end regions in the region of the dividing point, the annular end regions meshing with one another and each having a respective tab which rests radially on the inside on a support region of the other annular end region and being axially defined by the tab of the other annular end region.

28. The piston ring as defined by claim 27, wherein the piston ring is an injection-molded part.

29. The piston ring as defined by claim 27, further comprising spacers on its inside surface.

30. The piston ring as defined by claim 29, wherein the spacers are formed by axial ribs which are braced on the pump piston.
